(19) United States
(12) Patent Application Publication
(10) Pub. No.: US 2026/0253511 A1
(43) Pub. Date: Aug. 27, 2026

(54) METHOD AND DEVICE FOR AUTOMATICALLY GENERATING SIGN LANGUAGE

(71) Applicant: Electronics and Telecommunications Research Institute, Daejeon (KR)

(72) Inventors: Sung Yong SHIN, Daejeon (KR); Young Mi SONG, Daejeon (KR); Hyeon Beom YI, Daejeon (KR)

(73) Assignee: Electronics and Telecommunications Research Institute, Daejeon (KR)

(21) Appl. No.: 19/438,726

(22) Filed: Jan. 2, 2026

(30) Foreign Application Priority Data
Feb. 26, 2025 (KR) 10-2025-0025338

(51) Int. Cl. G09B 21/00

(52) U.S. Cl. CPC G09B 21/009

(57) ABSTRACT

A method and a device for automatically generating a sign language are disclosed. According to an embodiment of the present invention, a method for automatically generating a sign language, the method comprising: extracting linguistic features and non-linguistic features of music, temporally synchronizing the extracted linguistic features and non-linguistic features with lyrics data, generating an integrated sentence by combining the synchronized linguistic features and lyrics data, converting the generated sentence into expression data that is a basis for generating the sign language, converting the synchronized non-linguistic features into expression elements of a sign language motion, generating a script using the converted expression data and the converted expression elements of the sign language motion, and generating the sign language using the generated script.

### CROSS-REFERENCE TO RELATED APPLICATION

This application claims the benefit of and priority to Korean Patent Application No. 10-2025-0025338, filed on Feb. 26, 2025, the entire disclosure(s) of which is hereby incorporated herein by reference in its entirety.

### TECHNICAL FIELD

The present disclosure relates to a method and a device for automatically generating a sign language.

### BACKGROUND

The statements in this section merely provide background information related to the present disclosure and do not necessarily constitute prior art.

As interest of the hearing impaired in music increases, national policies to improve music accessibility for the hearing impaired are also expanding worldwide. However, currently, music translation technology for the hearing impaired is mainly focused on text and spoken language translation, and in the case of music, it is often limited to merely translating lyrics into a sign language. Therefore, it is difficult for the hearing impaired to fully experience the flow of the music or emotional elements because core musical elements such as rhythm, dynamics, and melody are not sufficiently conveyed.

In some performances, professional sign language interpreters are hired to convey the music more accurately, and employment of such interpreters has been increasing annually. However, the professional sign language interpreters who translate the music into the sign language are typically available only at a limited number of performances designed for people with disabilities or at large-scale productions with significant funding. Therefore, although today’s environment allows anyone to access the music easily through various platforms, services for the hearing impaired remain difficult to provide widely because of limited personnel and resources.

### SUMMARY

The present disclosure is mainly intended to automatically generate sign language expression data including linguistic music features and non-linguistic music features, and to provide a sign language expression animation and the like using the generated sign language expression data.

Problems to be solved by the present disclosure are not limited to the above-mentioned problems, and other problems not mentioned will be clearly understood by those skilled in the art from the following description.

An aspect of the present disclosure provides a method for automatically generating a sign language, the method comprising: extracting linguistic features and non-linguistic features of music; temporally synchronizing the extracted linguistic features and non-linguistic features with lyrics data; generating an integrated sentence by combining the synchronized linguistic features and lyrics data; converting the generated sentence into expression data that is a basis for generating the sign language; converting the synchronized non-linguistic features into expression elements of a sign language motion; generating a script using the converted expression data and the converted expression elements of the sign language motion; and generating the sign language using the generated script.

An aspect of the present disclosure provides a device comprising: at least one memory; and at least one processor, wherein the at least one processor is configured, by executing instructions, to: extract linguistic features and non-linguistic features of music; temporally synchronize the extracted linguistic features and non-linguistic features with lyrics data; generate an integrated sentence by combining the synchronized linguistic features and lyrics data; convert the generated sentence into expression data that is a basis for generating a sign language; convert the synchronized non-linguistic features into expression elements of a sign language motion; generate a script using the converted expression data and the converted expression elements of the sign language motion; and generate the sign language using the generated script.

According to an embodiment of the present disclosure, by reflecting not only lyrics-centered sign language translation but also musical elements such as rhythm, melody, and dynamics, the hearing impaired may experience the overall flow and emotional aspects of music in a richer manner and experience music with enhanced immersion.

According to an embodiment of the present disclosure, music content may be automatically translated into sign language, so that the hearing impaired may access a wide variety of music content regardless of time and location.

The effects of the present disclosure are not limited to the foregoing, and other effects not mentioned herein will be able to be clearly understood by those skilled in the art from the following description.

### BRIEF DESCRIPTION OF THE DRAWINGS

FIG. 1 is a block diagram schematically illustrating an automatic sign language generation device according to an embodiment of the present disclosure.

FIG. 2 is a diagram for illustrating a process in which a feature conversion module converts a non-linguistic feature into a detailed expression element of a sign language motion according to an embodiment of the present disclosure.

FIG. 3 is a diagram for illustrating a process of generating sign language expression data using lyrics data and linguistic features of music according to an embodiment of the present disclosure.

FIG. 4 is a diagram for illustrating a process of generating sign language expression data using only linguistic features of music according to an embodiment of the present disclosure.

FIG. 5 is a diagram for illustrating a sign language script generated by a script generation module according to an embodiment of the present disclosure.

FIG. 6 is a flowchart illustrating an operating process of an automatic generation device according to an embodiment of the present disclosure.

FIG. 7 is a block diagram of an exemplary computing device that may be used for implementing the method or the apparatus according to the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present disclosure and is not intended to represent the only embodiments in which the present disclosure may be practiced.

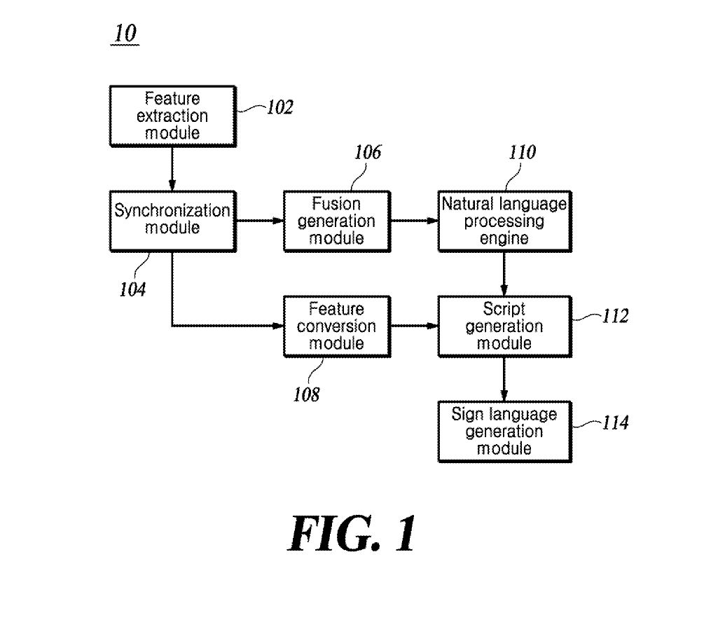

FIG. 1 is a block diagram schematically illustrating an automatic sign language generation device 10 according to an embodiment of the present disclosure. Components illustrated in FIG. 1 represent elements that are functionally distinguished from each other, and at least one component may be implemented in a form of being integrated with each other in an actual physical environment.

The automatic sign language generation device 10 (hereinafter, referred to as an "automatic generation device") according to an embodiment of the present disclosure may include all or some of a feature extraction module 102, a synchronization module 104, a fusion generation model 106, a feature conversion module 108, a natural language processing engine 110, a script generation module 112, and a sign language generation module 114. The automatic generation device 10 may receive sound source data and/or lyrics data, and automatically generate a sign language based on linguistic and non-linguistic features of music. The lyrics data may not exist depending on a genre or a type of the music. When the lyrics data does not exist, the automatic generation device 10 may automatically generate the sign language using only the sound source data.

The feature extraction module 102 may receive the sound source data from the outside and extract the linguistic features of the music and the non-linguistic features of the music. Here, the linguistic features of the music may include all musical properties that may be expressed in language, such as timbre and mood. The non-linguistic features of the music may include properties related to a musical structure such as pitch, dynamics, rhythm, and chord. The feature extraction module 102 may extract the linguistic features and the non-linguistic features using a signal processing technique and a deep learning-based feature extraction method.

The synchronization module 104 temporally synchronizes the lyrics data and the linguistic and non-linguistic features extracted from the feature extraction module 102. In other words, it means a process of creating a continuous flow by connecting musical features.

The fusion generation model 106 generates one integrated sentence by combining the temporally synchronized lyrics data and linguistic features of the music. That is, the fusion generation model 106 organizes the input lyrics data and/or linguistic features into natural sentences using a language model such as a large language model (LLM).

The feature conversion module 108 converts the non-linguistic features of the music into detailed expression elements of a sign language motion. Here, the detailed expression elements of the sign language motion may include a motion height of the sign language, a motion size of the sign language, an execution duration of the sign language, and the like, but may not be limited thereto.

The natural language processing engine 110 may segment an input sentence into morpheme units using, for example, a natural language Understanding (NLU) engine, project the morphemes into a vector space, group the projected vectors to classify an intention of the input sentence, and extract other components corresponding to slots of the intention in the input sentence as entities.

As an example, when the input sentence is "Star shining night, piano and violin brightly spread ", the NLU engine tokenizes the input sentence into "star", "shine", "night", "piano", "violin", "brightly", and "spread". Here, the tokenized words may be sign language expression data. In other words, "star, shine, night, piano, violin, brightly, spread" may be the sign language expression data that is the basis for the sign language generation.

The script generation module 112 may generate a sign language script using the sign language expression data and the detailed expression elements of the sign language motion. That is, the sign language expression data is input to a sign language expression data area of the sign language script based on a time sequence. The detailed expression elements of the sign language motion are in a form in which the non-linguistic features of the music have been transformed. The detailed expression elements of the sign language motion may be encoded in the script as elements that determine features of the sign language.

The sign language generation module 114 may generate the sign language using a final script including the sign language expression data and the features of the sign language. A sign language generation method may be expressed in a form of an avatar, an image, or an animation.

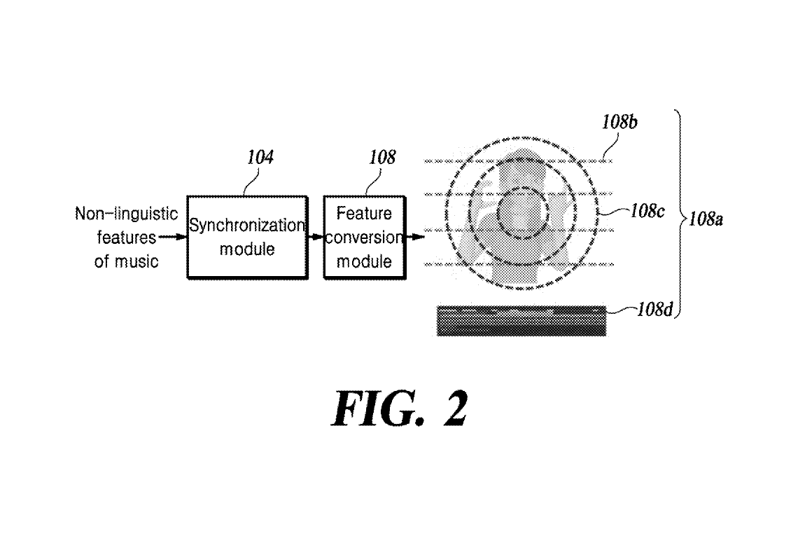

FIG. 2 is a diagram for illustrating a process in which the feature conversion module 108 converts the non-linguistic feature into a detailed expression element 108a of the sign language motion according to an embodiment of the present disclosure.

The feature conversion module 108 serves to determine performance features of the sign language by utilizing the non-linguistic features of the music. The non-linguistic features of the music may include the properties related to the musical structure such as pitch, dynamics, rhythm, and chord. However, the present disclosure proposes a method of generating the sign language features using pitch, strength, and rhythm among the related properties.

To extract the non-linguistic features from the music, various commercial software or open source tools may be used. The non-linguistic features are converted into the detailed expression elements 108a of the sign language motion via the feature conversion module 108.

Specifically, the pitch may be converted to the motion height of the sign language. The sign language motion height refers to a position where the sign language is expressed. Referring to FIG. 2, a portion illustrated by a dotted straight line means the motion height of the sign language. The motion heights shown in FIG. 2 are respectively levels 1, 2, 3, and 4 from the bottom, and the motion heights may be set to the levels 1, 2, …, N. Referring to FIG. 2, the feature conversion module 108 may convert the pitch up to a highest motion level 108b, that is, up to the level 4. For example, when a word 'love' is expressed in the sign language, when the pitch of the music is high, the pitch of the music may be reflected by implementing the sign language starting from a high position.

The dynamics may be converted into the motion size of the sign language. motion size of the sign language means a size of the motion when the sign language is generated. A strong musical element may be converted into a larger motion, and a weak musical element may be expressed as a small motion. Therefore, sign language expression that visually reflects the dynamics of the music becomes possible. Referring to FIG. 2, a portion illustrated by a circular dotted line means the motion size of the sign language. The motion sizes shown in FIG. 2 are respectively levels 1, 2, and 3 in a manner of expanding outward from a center of a circle. The motion sizes may be set to levels 1, 2, …, N. Referring to FIG. 2, the feature conversion module 108 may convert the dynamics up to a maximum motion range 108c, that is, up to the level 3.

The rhythm is converted into a sign language execution duration 108d that determines a start time and a duration of each sign language expression data. A speed of the sign language may be adjusted using the rhythm, and a difference in the execution speed may be clearly distinguished for each sign language expression data.

In one example, in the present disclosure, the motion heights and the motion sizes of the sign language are illustrated in the integer levels, but may not be limited thereto and may be converted into continuous values.

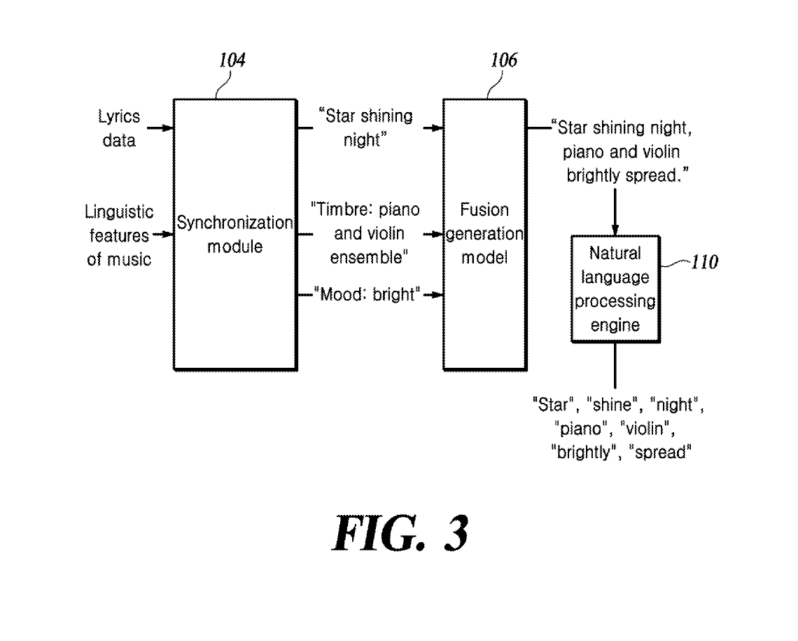

FIG. 3 is a diagram for illustrating a process of generating sign language expression data using lyrics data and linguistic features of music according to an embodiment of the present disclosure. To describe FIG. 3, FIG. 1 may be referred together.

The linguistic feature of the music means expression of the features of the music in language. The present disclosure provides an embodiment utilizing timbre and mood.

The linguistic features of the music are derived from the feature extraction module 102. Here, the linguistic features of the music may include all musical properties that may be expressed in language, such as timbre and mood. The linguistic features of the music and the lyrics data are subjected to the temporal synchronization process, and thus linguistic features and lyrics data at the same time point are mapped with each other. Because of the mapping process, linguistic features and lyrics data corresponding to a specific moment of the music may be connected as one sentence. The linguistic features and the lyrics data connected as the one sentence are then converted into an integrated sentence by the fusion generation model 106.

The fusion generation model 106 organizes the input lyrics data and linguistic features into natural sentences using the language model such as a large-scale language model. That is, the integrated sentence generated by the fusion generation model 106 is converted into the sign language expression data that is a sign language expression unit by the natural language processing engine 110. Therefore, the sign language expression data generated by the natural language processing engine 110 may be the basis of the sign language expression, and may enable sign language expression reflecting a fused meaning of the linguistic feature of the music and the lyrics data.

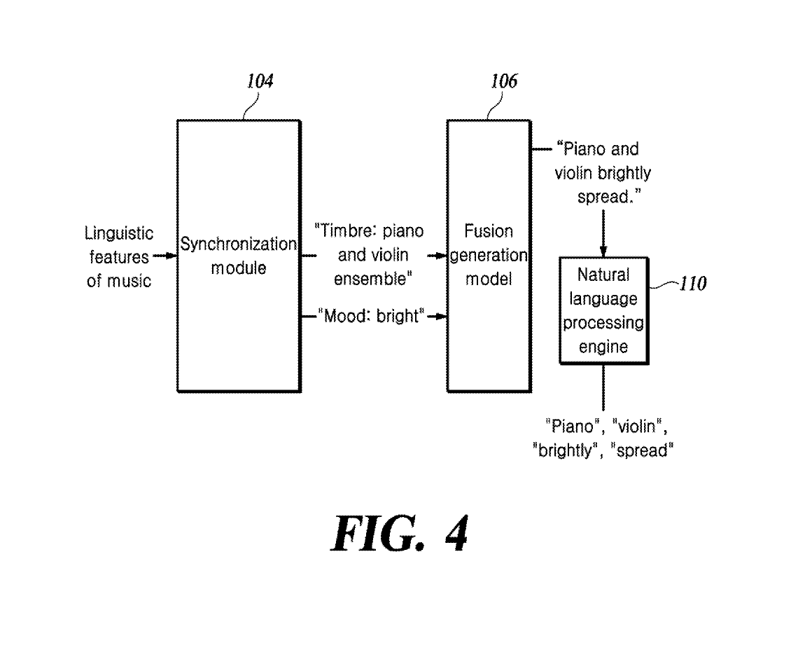

FIG. 4 is a diagram for illustrating a process of generating sign language expression data using only linguistic features of music according to an embodiment of the present disclosure.

Depending on the genre of the music, there may be instrumental songs that do not have any lyrics. Even in music containing lyrics, there may be portions without the lyrics in specific sections.

The fusion generation model 106 may generate the sign language expression data using only the linguistic features of the music even when there is no lyrics data. In the section without the lyrics data, the integrated sentence is generated based on the linguistic features of the music. Therefore, the musical features such as timbre, mood, and emotion may be converted into language and expressed. The generated integrated sentence is converted into the independent sign language expression data, which is the expression unit of the sign language, by the natural language processing engine 110, and thus, is completely prepared for implementation as the sign language.

Therefore, even when there is no lyrics or in the section without the lyrics, the integrated sentence reflecting the mood and feeling of the music may be generated and thus the sign language expression data that may be converted into the sign language may be generated. Referring to FIG. 4, the integrated sentence is "Piano and violin brightly spread", and the sign language expression data are "piano", "violin", "brightly", and "spread".

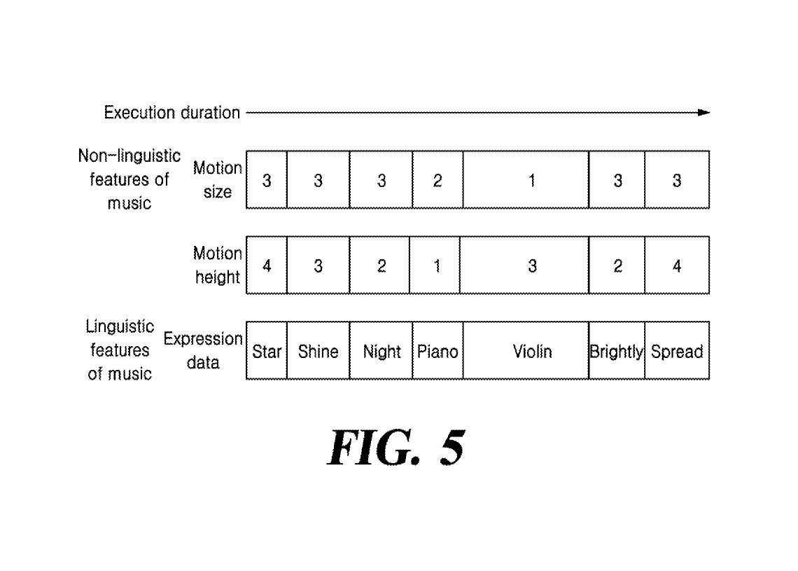

FIG. 5 is a diagram for illustrating a sign language script generated by the script generation module 112 according to an embodiment of the present disclosure. To describe FIG. 5, FIGS. 1 and 2 may be referred together.

The script generation module 112 may generate the sign language script using the sign language expression data and the detailed expression elements of the sign language motion. The script generation module 112 may first analyze the rhythm, which is one of the non-linguistic features, to determine a start time point and an end time point of each sign language expression data. Accordingly, each sign language expression data may be adjusted to be independently placed based on a passage of time. After the start time point and the end time point are determined, physical features of the sign language expression may be reflected by encoding a motion height of the sign language and a motion size of the sign language corresponding to each sign language expression data. The script generation module 112 may complete the final sign language script by combining the sign language expression data with the detailed expression elements of the sign language motion corresponding to each sign language expression data.

For example, when sign language expression data "shine" has a sign language motion height of the level 3 and a sign language motion size of the level 3, the sign language generation module 114 generates an animation for implementing the sign language with a size of approximately a width of shoulders starting from a height near a neck using the sign language expression data "shine". That is, the sign language generation module 114 enables sign language expression reflecting the lyrics data of "shine" and pitch and tone, which are musical elements of the lyrics data.

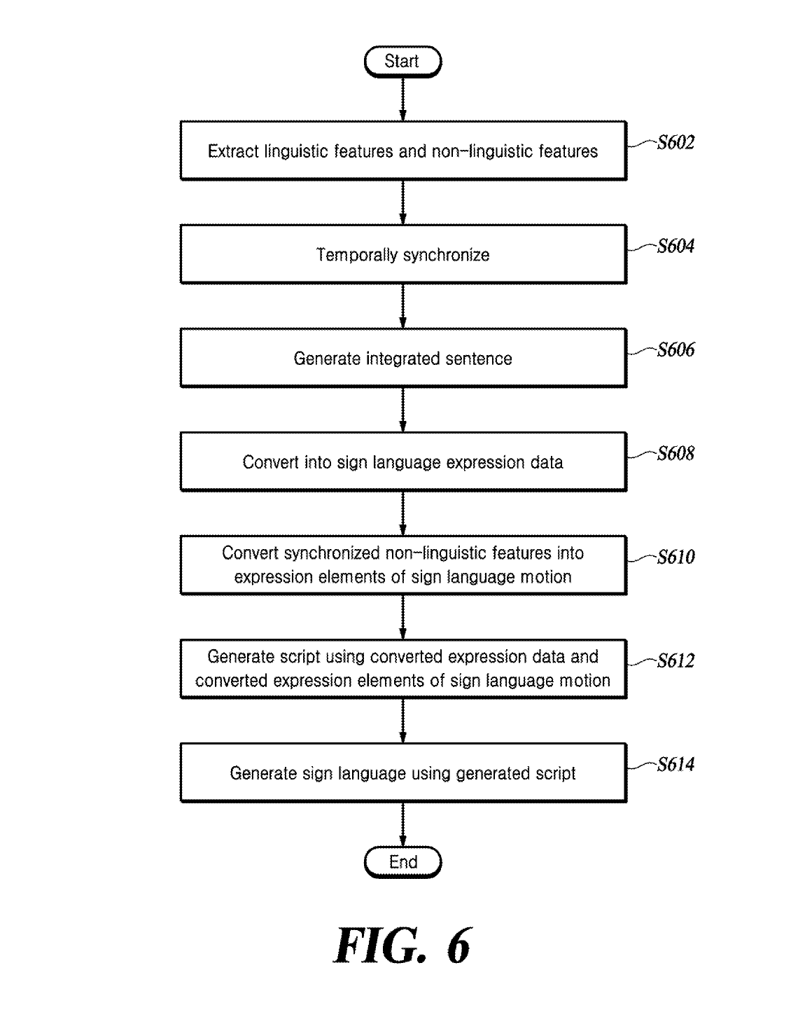

FIG. 6 is a flowchart illustrating an operating process of the automatic generation device 10 according to an embodiment of the present disclosure.

The feature extraction module 102 may receive the sound source data from the outside and extract the linguistic features of the music and the non-linguistic features of the music (S602). Here, the linguistic features of the music may include all the musical properties that may be expressed in the language, such as timbre and mood.

The synchronization module 104 temporally synchronizes the lyrics data and the linguistic and non-linguistic features extracted from the feature extraction module 102 (S604). In other words, it means the process of creating the continuous flow by connecting the musical features.

The fusion generation model 106 generates one integrated sentence by combining the temporally synchronized lyrics data and linguistic features of the music (S606).

The integrated sentence generated by the fusion generation model 106 is converted into the sign language expression data that is the sign language expression unit by the natural language processing engine 110 (S608). Therefore, the sign language expression data generated by the natural language processing engine 110 may be the basis of the sign language expression, and may enable the sign language expression reflecting the fused meaning of the linguistic features of the music and the lyrics data.

The feature conversion module 108 converts the synchronized non-linguistic features into the detailed expression elements of the sign language motion (S610). Here, the detailed expression elements of the sign language motion may include the motion height of the sign language, the motion size of the sign language, the execution duration of the sign language, and the like, but may not be limited thereto.

The script generation module 112 may generate the sign language script using the sign language expression data and the detailed expression elements of the sign language motion (S612). That is, the sign language expression data is input to the sign language expression data area of the sign language script based on the time sequence. The detailed expression elements of the sign language motion are in the form in which the non-linguistic features of the music have been transformed. The detailed expression elements of the sign language motion may be encoded in the script as the elements that determine the features of the sign language.

The sign language generation module 114 may generate the sign language using the final script including the sign language expression data and the features of the sign language (S614). The sign language generation method may be expressed in the form of the avatar, the image, or the animation.

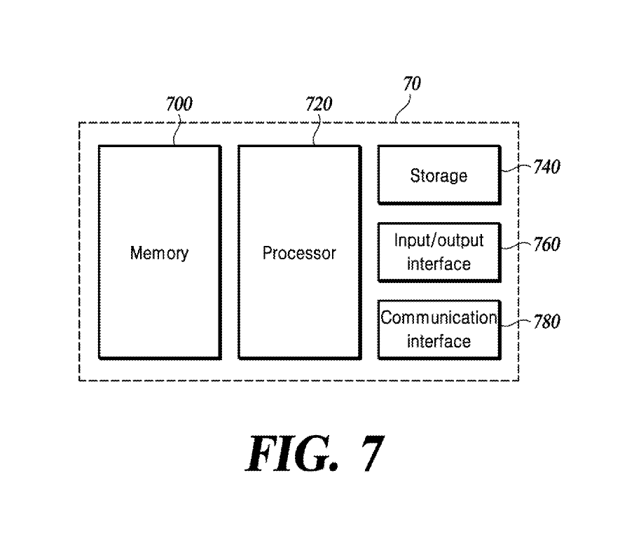

FIG. 7 is a block diagram of an exemplary computing device that may be used for implementing the method or the apparatus according to the present disclosure.

A computing device 70 may include some or all of a memory 700, a processor 720, storage 740, an input/output interface 760, and a communication interface 780. The computing device 70 may be a stationary computing device such as a desktop computer, a server, or the like, as well as a mobile computing device such as a laptop computer, a smartphone, or the like. The computing device 70 may include any specialized hardware accelerator capable of processing calculations on an artificial intelligence model in an efficient manner. For example, the computing device 70 may include a graphic processing unit (GPU), a tensor processing unit (TPU), or a neural processing unit (NPU).

The memory 700 may store a program that causes the processor 720 to perform a method or an operation according to various embodiments of the present disclosure. For example, the program may include a plurality of instructions executable by the processor 720, and the above-described method or operation may be performed by executing the plurality of instructions by the processor 720. The memory 700 may be a single memory or a plurality of memories. In this case, information necessary to perform the method or the operation according to various embodiments of the disclosure may be stored in the single memory or may be divided and stored in the plurality of memories. When the memory 700 is composed of the plurality of memories, the plurality of memories may be physically separated from each other. The memory 700 may include at least one of a volatile memory and a non-volatile memory. The volatile memory includes a static random access memory (SRAM) or a dynamic random access memory (DRAM), and the non-volatile memory includes a flash memory.

The processor 720 may include at least one core capable of executing at least one instruction. The processor 720 may execute the instructions stored in the memory 700. The processor 720 may be a single processor or a plurality of processors.

The storage 740 retains stored data even when power supplied to the computing device 70 is cut off. For example, the storage 740 may include a non-volatile memory, or may include a storage medium such as a magnetic tape, an optical disk, or a magnetic disk. A program stored in the storage 740 may be loaded into the memory 700 before being executed by the processor 720. The storage 740 may store a file written in a program language, and a program generated by a compiler or the like from the file may be loaded into the memory 700. The storage 740 may store data to be processed by the processor 720 and/or data processed by the processor 720.

The input/output interface 760 may provide an interface with an input device such as a keyboard, a mouse, and the like and/or an output device such as a display device, a printer, and the like. A user may trigger the execution of the program by the processor 720 through the input device and/or check a processing result of the processor 720 through the output device.

The communication interface 780 may provide access to an external network. The computing device 70 may be in communication with other devices via the communication interface 780.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A method for automatically generating a sign language, the method comprising:
extracting linguistic features and non-linguistic features of music;
temporally synchronizing the extracted linguistic features and non-linguistic features with lyrics data;
generating an integrated sentence by combining the synchronized linguistic features and lyrics data;
converting the generated sentence into expression data that is a basis for generating the sign language;
converting the synchronized non-linguistic features into expression elements of a sign language motion;
generating a script using the converted expression data and the converted expression elements of the sign language motion; and
generating the sign language using the generated script.

2. The method of claim 1, wherein the linguistic features include one or more of timbre and mood.

3. The method of claim 1, wherein the non-linguistic features include one or more of pitch, dynamics, rhythm, and chord.

4. The method of claim 1, wherein the expression elements of the sign language motion include one or more of a motion height of the sign language, a motion size of the sign language, and an execution duration of the sign language.

5. The method of claim 1, wherein the generating of the integrated sentence includes generating the sentence using only the linguistic features when the lyrics data does not exist.

6. The method of claim 1, wherein the generating of the script includes:
inputting the expression data into an expression data area based on a time sequence; and
encoding detailed expression elements of the sign language motion into the script.

7. A device comprising:
at least one memory; and
at least one processor,
wherein the at least one processor is configured, by executing instructions, to:
extract linguistic features and non-linguistic features of music;
temporally synchronize the extracted linguistic features and non-linguistic features with lyrics data;
generate an integrated sentence by combining the synchronized linguistic features and lyrics data;
convert the generated sentence into expression data that is a basis for generating a sign language;
convert the synchronized non-linguistic features into expression elements of a sign language motion;
generate a script using the converted expression data and the converted expression elements of the sign language motion; and
generate the sign language using the generated script.

8. The device of claim 7, wherein the linguistic features include one or more of timbre and mood.

9. The device of claim 7, wherein the non-linguistic features include one or more of pitch, dynamics, rhythm, and chord.

10. The device of claim 7, wherein the expression elements of the sign language motion include one or more of a motion height of the sign language, a motion size of the sign language, and an execution duration of the sign language.

11. The device of claim 7, wherein the generating of the integrated sentence includes generating the sentence using only the linguistic features when the lyrics data does not exist.

12. The device of claim 7, wherein the generating of the script includes:
inputting the expression data into an expression data area based on a time sequence; and
encoding detailed expression elements of the sign language motion into the script.
